(19) United States
(12) Patent Application Publication
(10) Pub. No.: US 2009/0188252 A1
(43) Pub. Date: Jul. 30, 2009

(54) METHOD AND APPARATUS FOR INCREASING THE EXHAUST GAS TEMPERATURE OF AN INTERNAL COMBUSTION ENGINE

(75) Inventors: Michael Kolitsch, Weissach (DE); Werner Christl, Moeglingen (DE); Ralf Wirth, Farmington Hills, MI (US); Andreas Fritsch, Waiblingen (DE); Dirk Samuelsen, Remseck Am Neckar (DE); Stefan Motz, Moeglingen (DE); Carsten Becker, Kernen I.R. (DE); Tobias Pfister, Stuttgart (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/280,320

(22) PCT Filed: Jan. 23, 2007
(86) PCT No.: PCT/EP2007/050646

§ 371 Date: Oct. 28, 2008

(30) Foreign Application Priority Data
Feb. 22, 2006 (EP) 102006008228.1

(51) Int. Cl. F02D 23/00; F02B 47/08; F01N 3/00; F01N 3/02

(52) U.S. Cl. 60/602; 123/568.21; 60/287; 60/295; 60/311

(57) ABSTRACT

The invention relates to a method and an apparatus for temporarily increasing the temperature in the exhaust gas of an internal combustion engine, comprising at least two associated turbochargers with a respective compressor in a fresh air feed to the internal combustion engine and a respective turbine in an exhaust gas line of the internal combustion engine, wherein a bypass is assigned to at least one compressor and/or one turbine, and comprising at least one exhaust gas retreatment system connected downstream of the turbines in the exhaust gas direction. In this case, the volumetric flow of fresh air and/or of exhaust gas directed past at least one compressor and/or one turbine through the bypasses is increased via regulating elements in the bypasses, which leads to a reduction in the charge pressure and hence to a reduction in the efficiency of the internal combustion engine and to an increase in the exhaust gas temperature.

### TECHNICAL FIELD

The invention relates to a method for temporarily increasing the temperature in the exhaust gas of an internal combustion engine, comprising at least two associated turbochargers with a respective compressor in a fresh air feed to the internal combustion engine and a respective turbine in an exhaust gas line of the internal combustion engine, wherein a bypass is assigned to at least one compressor and/or one turbine, and comprising at least one exhaust gas retreatment system connected downstream of the turbines in the exhaust gas direction.

The invention further relates to an apparatus for temporarily increasing the temperature in the exhaust gas of an internal combustion engine, comprising at least two associated turbochargers with a respective compressor in a fresh air feed to the internal combustion engine and a respective turbine in an exhaust gas line of the internal combustion engine, wherein a bypass is assigned to at least one compressor and/or one turbine, and comprising at least one exhaust gas retreatment system connected downstream of the turbines in the exhaust gas direction.

Provision is frequently made in the exhaust gas retreatment system for components, which have to be regenerated from time to time. Provision can, thus, be made for particle filters in the exhaust gas retreatment system of diesel engines, which have to be regenerated when the storage capacity is reached; or catalytic converters can be employed, such as for example the so-called DENOX catalytic converters, which likewise have to be cleared of sooty accumulations by an increased exhaust gas temperature.

### BACKGROUND

In the text of the German patent DE 199 23 299, a method for the open-loop control of an internal combustion engine is described, which comprises wherewithal, which influences the exhaust gas of the internal combustion engine; and in so doing, a special operating state is initiated when certain conditions are present. In this special operating state, an increased energy volume is desired and a 50% mass fraction burned (MFB) is thereby influenced in such a way that the exhaust gas temperature increases. The 50% mass fraction burned (MFB) is thereby shifted in the direction of occurring later in the combustion cycle.

Particularly in the case of two-stage turbocharged internal combustion engines, a significant increase in the degree of efficiency is achieved in comparison with the single-stage turbocharged internal combustion engines. For this reason, additional measures are necessary to reduce the degree of efficiency to a point where a sufficient increase in temperature is achieved.

It is the task of the invention to provide a method, which makes a sufficient temperature increase in the exhaust gas of two-stage turbocharged internal combustion engines possible and in so doing does not significantly influence the operating characteristics of the internal combustion engine.

Furthermore, it is the task of the invention to provide an apparatus for this purpose.

### SUMMARY

The task of the invention relating to the method is thereby solved, in that the volumetric flow of fresh air and/or of exhaust gas directed past at least one compressor and/or one turbine through bypasses is increased via regulating elements in the bypasses. This increase in said volumetric flow leads to a reduction in the charge pressure and hence to a reduction in the efficiency of the internal combustion engine. A reduction in the efficiency leads to a desired increase in the exhaust gas temperature. Because less exhaust gas is channeled across the turbocharger(s) in the method, they are protected from overpressure and overheating. The heating of the exhaust gas system and the exhaust gas retreatment systems, which are contained therein, takes place quickly because more hot exhaust gas flows via the bypasses past the turbines of the turbochargers, at which the heat energy is extracted from the exhaust gas. Due to the high exhaust gas temperature and to the fact that the turbines are not completely circumvented, a rapid buildup in the charge pressure additionally occurs. Consequently the rapid buildup in torque, which is known from the normal operation of two-stage turbocharged internal combustion engines, remains intact.

An additional reduction of the charge pressure and in so doing the degree of efficiency of the internal combustion engine can thereby be achieved, in that the degree of efficiency of at least one turbine is reduced by a variable turbine geometry or a bypass.

Provision is made in a preferred form of embodiment of the invention for the increase in temperature of the exhaust gas during regeneration to be implemented by at least one component of the exhaust gas retreatment system; and in so doing, the activation of the regulating elements is performed by a control unit as a function of a regeneration requirement of the component, which has been ascertained. With regard to the component, a particle filter, for example, is involved, wherein the accumulated particles are burned at the increased temperature; or a catalytic converter, for example a so-called DENOX catalytic converter, can be involved, wherein accumulations, especially of sulfur and/or sulfur compounds, are removed by increasing the temperature in the exhaust gas in certain intervals.

If provision is made for the regulating elements to be adjusted according to the most favorable adjustments for the operation of the internal combustion engine, for the regulating elements to be opened wider during a phase with an increase in exhaust gas temperature in comparison to the normal operating phase and for the regulating elements, dependent on the operating parameters of the internal combustion engine, to continuously be opened during a transition phase between the normal operating phase and the phase with an increase in exhaust temperature, the internal combustion engine can then be operated with the optimal charge pressure, while the charge pressure is reduced by the regulating elements being opened wider in order to increase the temperature of the exhaust gas. The activation of the regulating elements in the transition phase takes place along a ramp, whose gradient can be designed according to its effect on the vehicle operation.

An operation of the turbochargers, which is controlled in a closed loop and adapted to the conditions and demands including those during the phases with an increased exhaust gas temperature, can thereby be achieved; in that during phases with an increased exhaust gas temperature, nominal values and control parameters are adapted by charge-pressure and turbine speed regulators deposited in the control unit. These differ as a rule from the specified nominal values in the normal operation.

In order to achieve the required increase in temperature in the exhaust gas, it may be necessary for additional, accompanying measures for increasing the temperature in the exhaust gas to be taken, which reduce the degree of efficiency of the internal combustion engine. Provision can be made, for example, for the 50% mass fraction burned (MFB) to be shifted rearwards in the combustion cycle or for additional, known methods to be used.

The task of the invention relating to the apparatus is thereby solved, in that regulating elements are disposed in the bypasses, by which the volumetric flow of fresh air and/or of exhaust gas through the bypasses can be adjusted, in that the opening of the regulating elements can be adjusted by a control unit and in that during phases with an increased exhaust gas temperature, at least one regulating element is opened wider in comparison with normal operating phases. More fresh air, respectively exhaust gas, flows past the compressor, respectively the turbine of the turbocharger, due to the regulating elements being opened wider, which leads to a reduced charge-pressure and in so doing to a reduced degree of efficiency with the increase in exhaust gas temperature, which is thereby caused. In the process, provision can be made for one or several regulating elements, respectively said regulating elements can be activated. As a result of sensor data, which ascertain the operating state of the internal combustion engine, the condition of the exhaust gas and/or the exhaust gas retreatment system, the control unit decides on the basis of the operating parameters of the internal combustion engine currently available to the control unit and/or on the basis of predicted conditions of the exhaust gas and/or the exhaust gas retreatment system, when a phase with an increased exhaust gas temperature is initiated.

A cost effective and reliable configuration can thereby be achieved, in that provision is made for actuable butterfly valves, seat valves or check valves to be regulating elements.

Provision is made in a preferred embodiment of the invention for a two-stage turbocharged diesel engine to be designated as the internal combustion engine and for the exhaust gas retreatment system to contain a particle filter. Two-stage turbocharged diesel engines are currently being launched onto the market. They are distinguished by an improved degree of efficiency in comparison to a one-stage turbocharging. This improved degree of efficiency makes the increase in the exhaust gas temperature necessary for the regeneration of the particle filter difficult when the reduction of the efficiency of the internal combustion engine is performed according to known methods. At the same time, the thermal inertia due to the obstructing particles additionally accumulated is increased in such systems. In that fresh air, respectively exhaust gas is directed past the turbochargers, the charge pressure and hence the efficiency of the diesel engine can be sufficiently reduced in order to achieve the exhaust gas temperature required for the regeneration of the particle filter. Furthermore, the thermal inertia of the system is decreased because a greater proportion of the hot exhaust gas is led pas the turbines.

### BRIEF DESCRIPTION OF THE DRAWING

The invention is explained below in detail using an example of embodiment depicted in the FIGURE. The following is shown:

FIG. 1 is a schematic depiction of an apparatus for increasing the exhaust gas temperature of an internal combustion engine.

### DETAILED DESCRIPTION

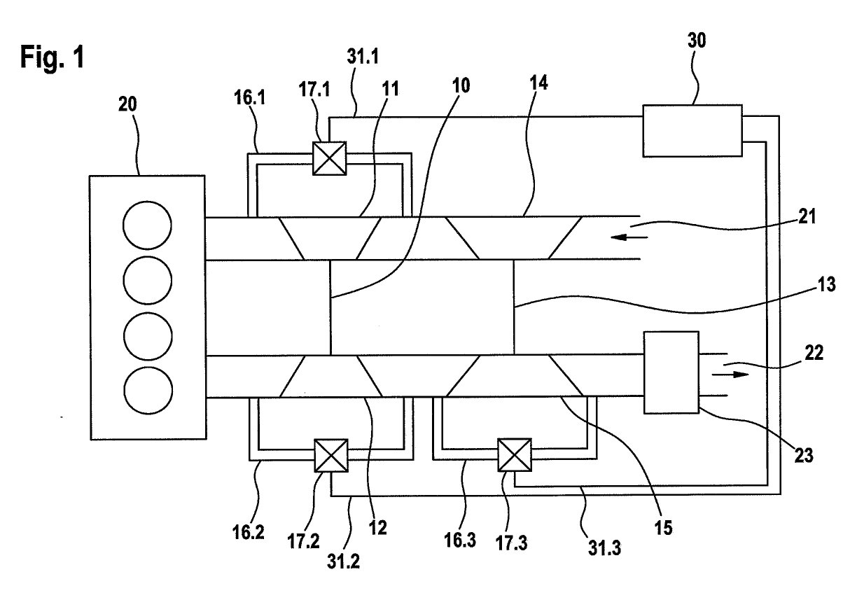

FIG. 1 shows in a schematic depiction an apparatus for increasing the exhaust gas temperature of an internal combustion engine 20. The internal combustion engine 20 is provided with fresh air via a fresh air feed 21, while the exhaust gas is discharged via an exhaust gas line 22. A first and a second turbine 12, 15 of two turbochargers 10, 13 are integrated into the exhaust gas line 22. A first and a second compressor 11, 14 of both turbochargers 10, 13 are disposed in the fresh air feed 21. A first bypass 16.1 with a first regulating element 17.1 is connected in parallel to the first compressor 11. A second bypass 16.2 with a second regulating element 17.2 is likewise assigned to the first turbine 12, and a third bypass 16.3 with a third regulating element 17.3 is assigned to the second turbine 15. The regulating elements 17.1, 17.2, 17.3 are connected via signal lines 31.1, 31.2, 31.3 to the control unit 30. An exhaust gas retreatment system 23 is disposed in the exhaust gas line 22 downstream of the second turbine 15 in the exhaust gas direction.

In the depicted variation of the embodiment, the internal combustion engine 20 represents a two-stage turbocharged diesel engine with a particle filter integrated in the exhaust gas retreatment system 23. Additional components of the air system, such as throttle valves, sensors and the like are not depicted.

The turbines 12, 15 of the turbochargers 10, 13 and in addition the compressors 11, 14 in the fresh air feed 21 are driven by the exhaust gas stream. The compressors 11, 14 produce the charge pressure for the internal combustion engine 20. Fresh air can be fed past the first compressor 11 to the internal combustion engine 20 via the bypass 16.1. The volumetric flow of fresh air flowing across the first bypass 16.1 can be adjusted by the first regulating element 17.1. Exhaust gas can be led past the respective turbines 12, 15 via the second and third bypass 16.2, 16.3. The volumetric flow of exhaust gas, which was respectively led past said turbines 12, 15, can be adjusted with the regulating elements 17.2, 17.3. The activation of the regulating elements 17.1, 17.2, 17.3 is carried out by the control unit 30, and in so doing the corresponding control signals are fed to the regulating elements 17.1, 17.2, 17.3 via the signal lines 31.1, 31.2, 31.3.

The exhaust gas temperature of the internal combustion engine 20 is significantly dependent on its degree of efficiency, which in turn depends on the charge pressure built up. A drop in the charge pressure leads to an increase in the exhaust gas temperature. This is thereby achieved according to the invention, in that at least one of the regulating elements 17.1, 17.2, 17.3 is opened wider. In the case of the first regulating element 17.1, a greater part of the fresh air, which has been supplied, is led in the process past the first compressor 11 and is therefore not compressed, which leads to the desired reduction in the charge pressure. In the case of the second and the third regulating elements 17.2, 17.3, a larger quantity of exhaust gas is directed past the turbines 12, 15 of the turbochargers 10, 13, which leads to a reduced propulsion of the turbines 12, 15 and thereby likewise to a reduced charge pressure.

If a regeneration of the particle filter contained in the exhaust gas retreatment system 23 is to be implemented, the control unit 30, thus, initiates the increase in temperature in the exhaust gas via a corresponding opening of the regulating elements 17.1, 17.2, 17.3 and consequently the regeneration of the particle filter. After the regeneration has been concluded, the regulating element 30 again adjusts the openings of the regulating elements 17.1, 17.2, 17.3 to settings intended for the normal operation.

Three modes of operation can thus be defined for the operation of the internal combustion engine. They are the normal operation, the regeneration operation and the transition operation.

In the normal operation, the regulating elements 17.1, 17.2, 17.3 are adjusted according to known systems.

In the regeneration operation, the regulating elements 17.1, 17.2, 17.3 are opened wider in comparison to the normal operation. In so doing, provision can be made for bypasses 16.1, 16.2, 16.3 for all of the turbines 12, 15 and compressors 11, 14 or only for apart of them; or all or only a part of the regulating elements 17.1, 17.2, 17.3 can be actuable. In addition to the gas streams, which have been redirected through bypasses, the degree of efficiency of the turbines 12, 15 can be reduced by way of an unspecified adaptation mechanism. The nominal values and parameters of the charge-pressure and turbine speed regulators present in the control unit 30 are accordingly adapted in the regeneration operation.

In the transition operation, switching is done between the activation rates of the regulating elements 17.1, 17.2, 17.3 in the normal operation and in the regeneration operation with the help of a ramp, whose gradient is designed corresponding to the effect on the vehicle operation.

1-12. (canceled)

13. A method of optimizing a consumption of a hybrid drive, especially a hybrid drive for a motor vehicle comprising an internal combustion engine provided with a plurality of cylinders and at least one electric engine, wherein the internal combustion engine and the at least one electric engine are operated in parallel in a hybrid mode, the method comprising:
disconnecting at least one of the plurality of cylinders in a partial load range of the internal combustion engine; wherein the at least one electric engine at least partially compensates for a variation in at least one of the internal combustion engine power or the internal combustion engine power requirement.

14. A method according to claim 13, further comprising disconnecting more of the plurality of cylinders during a smaller power requirement on the hybrid drive than during a larger power requirement; wherein the remaining of the plurality of cylinders that are not disconnected operate more efficiently.

15. A method according to claim 13, further comprising selecting at least one operating parameter of the plurality of cylinders that are not disconnected such that the efficiency of the internal combustion engine is maximized and the internal combustion power is adapted to the power requirements.

16. A method according to claim 15, wherein the at least one operating parameter determines one of:
a. a fuel supply;
b. a combustion air supply; or
c. an ignition timing.

17. A method according to claim 16, wherein the ignition timing is independent of other operating parameters for an internal combustion engine with an externally-supplied ignition.

18. A method according to claim 13, further comprising controlling the electric engine in an open loop or a closed loop such that when the internal combustion engine is running rough, power fluctuations resulting from the rough running are compensated by the electric engine.

19. A method according to claim 13, further comprising disconnecting respective cylinders of the plurality of cylinders at different times, especially cyclically, during a partial load operating mode.

20. A method according to claim 13, wherein kinetic energy of the motor vehicle when braking is utilized by an electric generator to charge an electrical storage unit assigned to the electric engine.

21. A method according to claim 13, wherein the at least partial compensation by the electric engine takes place only when a charging state of an electrical storage unit is above a specified charging threshold.

22. A method according to claim 20, wherein the electrical storage unit is a rechargeable battery.

23. A method according to claim 20, wherein the electric generator is an element of the electric engine.

24. A method according to claim 13, wherein each of the plurality of cylinders are provided with at least one valve, wherein the at least one valve of a disconnected cylinder is set such that a loss arising from a gas conveyance and/or mechanical work is reduced.
